(19) United States
(12) Patent Application Publication
(10) Pub. No.: US 2002/0069115 A1
(43) Pub. Date: Jun. 6, 2002

(54) Best deal and availability determiner

(75) Inventor: James Michael Fitzpatrick, Newport Beach, CA (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Catalina Marketing International, Inc., St. Petersburg, FL (US)

(21) Appl. No.: 09/726,561

(22) Filed: Dec. 1, 2000

(51) Int. Cl. G06F 17/60

(52) U.S. Cl. 705/26

(57) ABSTRACT

A method, system and computer program product for online shopping. The system on which the method and computer program product are based determines a shopping district for a customer based on customer-derived information, generates a present order list of at least one item to price, selects from a global database of retailers those selected retailers within the shopping district selling the items, and forms a selection list of the selected retailers. The list indicates the price and availability of the items on the selection list. A shopping basket including selected items and prices of the selected items is determined from the list of selected retailers. A to-be-purchased list is formed for at least a part of the shopping basket list which the customer confirms. The to-be-purchased list is used to generate purchase coupons for redemption at a confirmed retailer. Alternatively, the to-be-purchased list is direct ordered from each confirmed retailer.

### BACKGROUND OF THE INVENTION

1. Field of the Invention

This invention relates to a shopping method, system, and computer-program product which provides a customer with comparative pricing and availability of a specific item, or comparative pricing and availability for a group of items.

2. Discussion of the Background

When a customer seeks to purchase a specific item on current computer shopping systems, a customer has to rely on searching or search engines to determine the prices of each individual item. In some online shopping services such as priceline.com, as described in U.S. Pat. No. 6,085,169, the entire contents of which are incorporated herein by reference, the customer is able to input a price that they are willing to pay for a pre-selected product which the shopping service is offering for sale. The customer submits his offer and waits to see if the price is accepted by the retailer. While such systems offer the customer with a mechanism for bidding on a particular item which the customer desires to purchase, the customer cannot determine comparative prices and availability of a particular item and cannot bid on products not pre-selected by the shopping service. Further, a customer who wishes to buy a group of specific items has no mechanism for determining if discounts for the group purchase are available.

Without recourse, the customer must competitively price each specific item in the group and determine from those individual items what the cost for a group of individual items will be. If the customer has the patience to complete this process, the consumer must now purchase each individual item selectively from those retailers providing the lowest price, thus adding additional time and labor to complete acquisition of the group of items.

Additionally, the customer may, in the acquisition process, discover that particular items are unavailable from specific retailers, forcing the customer to return to the shopping system to re-order items.

### SUMMARY OF THE INVENTION

Accordingly, one object of the present invention is to provide customers with access to a global database of retailers' price files.

Another object of the present invention is to provide the customer with a selected display of retailers' price files within a predetermined shopping district for the customer. The selected display includes availability information on each item in the database. In one embodiment of the present invention, the availability information includes inventory, price history, availability history, and shopping hours available to the customer.

Still another object of the present invention is to provide the customer with comparative pricing of a particular item between a number of different retailers.

A further object of the present invention is to provide the customer with prices and availability of items at the retailer not restricted to particular sizes or brands which the retailer or the on-line shopping merchant may be promoting. Price discounts for promotional items are reflected in the global database. The customer is free to choose those promotional items or choose to purchase non-discounted items in which the customer may be more familiar.

Yet another object of the present invention is to provide a comparative pricing for a group of specific items whereby the consumer is free to buy collectively a group of items from a selected retailer rather than having to individually purchase each particular item from a plurality of retailers.

Another object of the present invention is to define a shopping district in which the customer is willing to purchase items. The shopping district, in turn, restricts the database to those retailers within the shopping district. In one embodiment of the present invention, the shopping district is defined based on customer-derived information such as an entered address and an entered travel-distance in which the customer is willing to travel. In another embodiment of the present invention, the shopping district is remote from a customer's residential or business address.

Still a further object of the present invention is to provide the customer with a price list for individual items or a price list for a group of items at a particular store along basic information such as for example a store description, travel distance to the store, travel directions to the store, directions to the store from within a shopping complex such as a mall, and the location of nearby restaurants or entertainment complexes.

These and other objects of the present invention are provided for in a method, system and computer program product for computer-implemented shopping. The system on which the method and computer program product are based determines a shopping district for a customer based on customer-derived information, generates a present order list of at least one item to price, selects from a global database of retailers those selected retailers within the shopping district selling the items, and forms a selection list of the selected retailers. The list indicates the price and availability of the items on the selection list. A shopping basket including selected items and prices of the selected items is determined from the list of selected retailers. A to-be-purchased list is formed for at least a part of the shopping basket list which the customer confirms. The to-be-purchased list is used to generate purchase coupons for redemption at a confirmed retailer. Alternatively, the to-be-purchased list is direct ordered from each confirmed retailer.

Thus, the present invention provides the user with advantages of comparison shopping between a plurality of retailers whose products, price, and availability are apparent before the customer places an order. Further, the shopping process of the present invention may be implemented on a computer readable medium which stores data to implement the on-line shopping process on a computer such as a general purpose computer or a network of general purpose computers.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a block diagram showing the implementation of the present invention on a computer system;

FIG. 2 is an illustrative table showing a global data base of retailers according to the present invention;

FIG. 3 is an illustrative table showing a control data base according to the present invention;

FIG. 4 is a flowchart showing a selecting process of the shopping method of the present invention;

FIGS. 5A and 5B are exemplary depictions of purchase coupons according to the present invention;

FIG. 6 is a flowchart showing a purchasing process utilizing the shopping method of the present invention;

FIG. 7 is a flowchart showing another purchasing process utilizing the shopping method of the present invention; and

FIG. 8 is a schematic illustration of a computer system programmed to perform one or more of the special purpose functions of the present invention.

### DESCRIPTION OF THE EMBODIMENTS

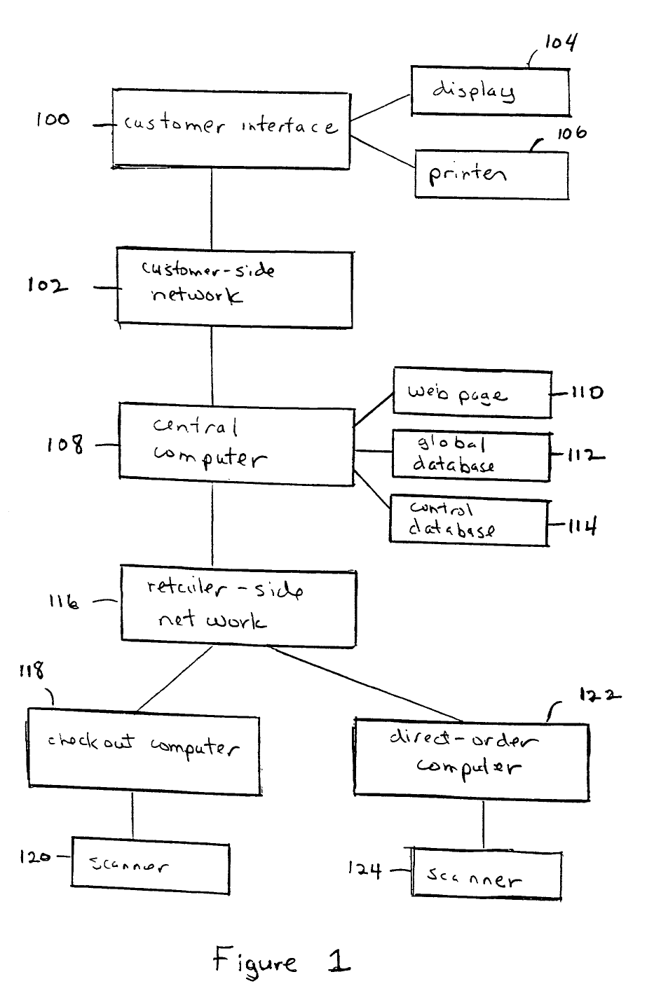

Referring now to the drawings, wherein like reference numerals designate identical or corresponding parts throughout the several views, and more particularly to FIG. 1 thereof, FIG. 1 is a block diagram showing the implementation of the present invention on a general purpose computer/network.

A customer interface 100 is provided. The customer interface 100 can be a personal computer or other device such as a telephone for accessing a customer-side network 102. The customer-side network 102 is any suitable hardware and software for communicating to the customer interface including, for example, the communications controller 824 and the network 828 shown in the computer system 802 of FIG. 8, or any suitable Internet connection. The customer interface 100 has a display 104 connected to a printer 106 which prints purchase coupons or a list of shopping basket items.

The customer side network 102 is connected to a central computer 108. The central computer 108 includes a web page 110 or other electronic page for communicating with the customer, a global database 112, and a control database 114. The central computer 108 is any suitable personal computer, workstation, server, or other device, such as the computer system 802 of FIG. 8. The central computer 108 communicates to the customer interface 100 using any suitable protocol and may be implemented using the computer system 802 of FIG. 8, for example.

In one embodiment of the present invention, the central computer 108 through the web page 110 shows which retailers have in stock the available items and allows the user to individually select items from each retailer. The present invention, upon user selection, concatenates the selected items into a shopping basket.

In another embodiment of the present invention, the central computer 108 through the web page 110 displays only those retailers from the provided retailer list in which the user will purchase items, such as for example, retailers in which the user has had satisfactory experience with in the past.

In another embodiment of the present invention, the central computer 108 generates a list of shopping basket items based on a minimization of total cost for the group of specific items.

The present invention stores information relating to various customers who shop utilizing the present invention as well as availability and prices of individual products. This information is stored in one or more memories such as a hard disk, optical disk, magneto-optical disk, and/or RAM, for example. One or more databases, such as the global database 112 and the control database 1134, may store the information used to implement the present invention. The databases are organized using data structures (e.g., records, tables, arrays, fields, graphs, trees, and/or lists) contained in one or more memories, such as the memories listed above or any of the storage devices listed below in the discussion of FIG. 8, for example.

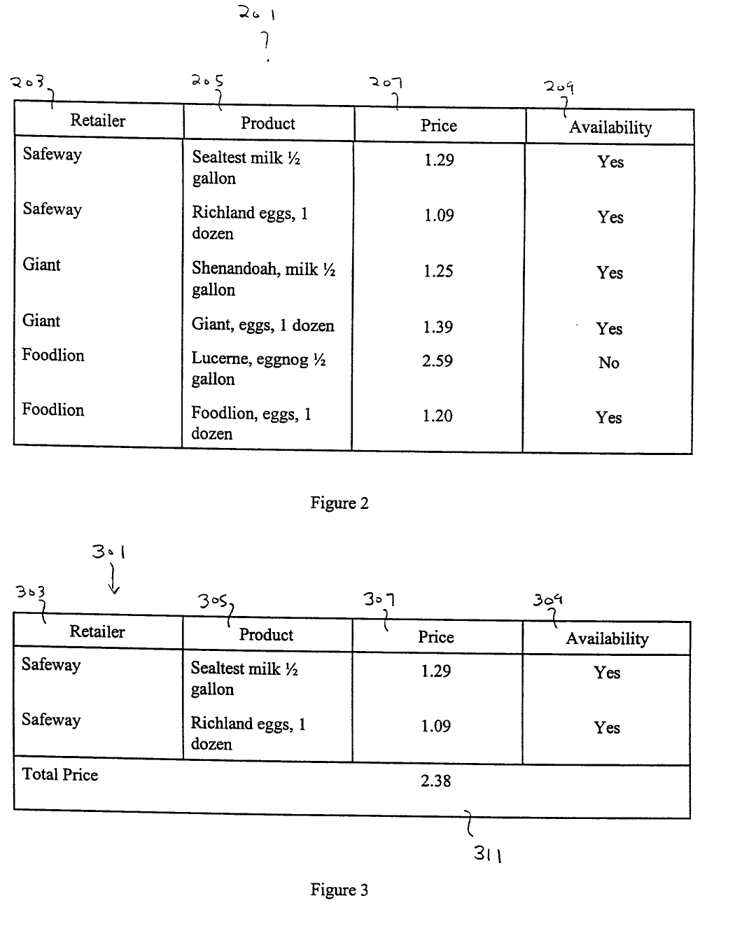

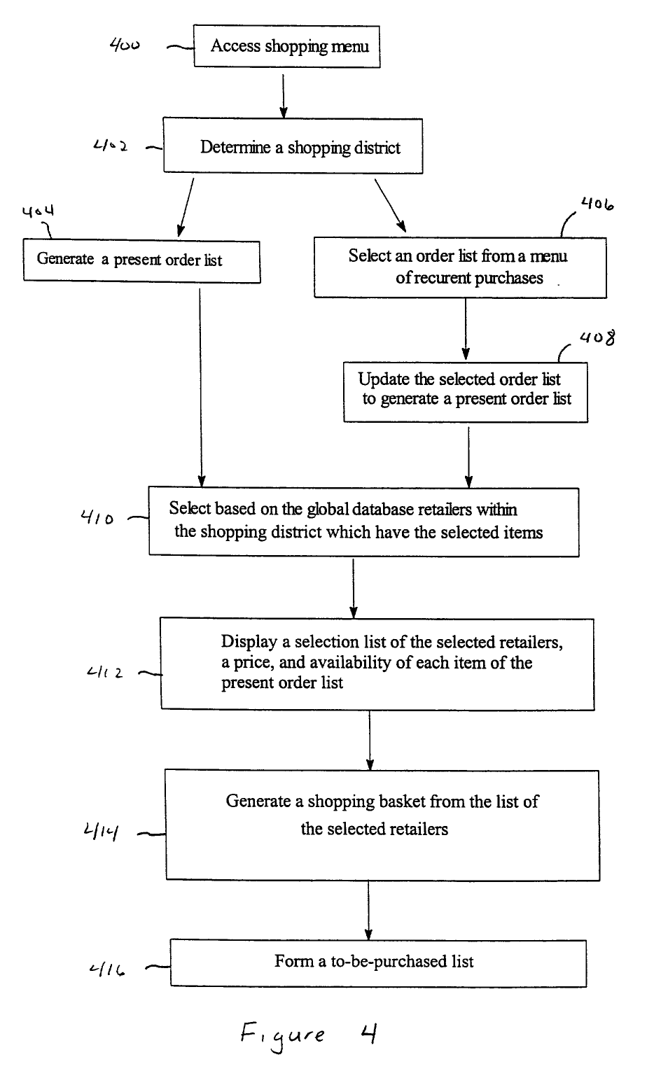

FIGS. 2 and 3 depict data structures used for implementing a system for providing products, prices and availability in accordance with an embodiment of the present invention. The data structures are depicted in a relational format, using tables, whereby information stored in one column (i.e., field) of a table is mapped or linked to information stored in the same row (i.e., record) across the other column(s) of the table. These data structures are used by the central computer 108 and/or the checkout computer 118 or the direct-order computer 122 to provide a list of products, prices and availability to customers. The data structures shown in FIGS. 2 and 3 are stored in the global database 112 and the control database 114, and/or any other suitable storage device(s) or medium(s).

FIG. 2 is a product-price-availability table 201 which may be stored in the global database 112. The product-price-availability table 201 includes a field 203 for storing retailer identification, a field 205 for storing product descriptions of the products in the field 203, a field 207 for storing the prices of the products, and a field 209 for storing a flag to determine if the listed retailer has the product in stock. The product-price-availability table 201, created by the central computer 108, shows only those retailers within the specified shopping district which have the selected products. The user can then choose from the product-price-availability table 201 which products are to be purchased, creating a shopping basket of items.

FIG. 3 is a shopping basket table 301 which may be stored in the control database 114. The shopping basket table 301 includes a field 303 for storing retailer identification, a field 305 for storing product descriptions of the products in the field 303, a field 307 for storing the prices of the products, and a field 311 for storing the total price of those items in the shopping basket. The data structure in FIG. 3 is similar to that in FIG. 2. The user selects which items to purchase. (in this example from one particular merchant, Safeway) The selected items are grouped in the control database 114, and a total price for the purchase of the selected items is determined. The selected items with the individual and the total group prices constitute a shopping basket. Prices of the shopping basket items are dependent from the prices contained in the global database 112. However, promotional sales, by the merchant or an on-line shopping service provider, may reduce the actual price to below the shopping basket price.

Records in the global database and the control database contain fields together with a set of operations for searching, sorting, recombining, and other database functions. One or more of U.S. Pat. Nos. 5,832,457; 5,649,114; 5,430,644; and 5,592,560 describe techniques for collecting consumer purchase history information and for storing such information in databases such as the global database 112 and the control database 114, for example. U.S. Pat. Nos. 5,832,457; 5,649,114; 5,430,644; and 5,592,560 are incorporated herein by reference. Additionally, techniques for collecting consumer purchase information and for storing such information in databases, such as the global database 112 and the control database 114, are described in other patents owned by Catalina Marketing and/or Catalina Marketing International. Each patent owned by Catalina Marketing and/or Catalina Marketing International is incorporated herein by reference.

The central computer 108 is further connected to a retailer-side network 116 which networks the central computer 108 to retail stores participating in the on-line shopping process of the present invention. The retailer-side network 116 is any suitable hardware and software for communicating to the customer interface including, for example, the communications controller 824 and the network 828 shown in the computer system 802 of FIG. 8, or any suitable Internet connection. At the retail stores, the shopping basket items are identified, and the prices are downloaded from the control database 114.

In one embodiment of the present invention, the customer purchases the shopping basket items (perhaps along with other items) at the retailer. In which case, a scanner 120 and a checkout computer 118 identify and capture, respectively, the price of the shopping basket items.

The checkout computer 118 is any suitable personal computer workstation, server, or other device, such as the computer system 802 of FIG. 8. The checkout computer 118 communicates to the retailer side network 116 using any suitable protocol and may be implemented using the computer system 802 of FIG. 8, for example.

The scanner 120 may be implemented as any conventional scanning device for reading product information such as an item code (e.g., UDC, EAN, or JAN) from bar codes or other indicia on the product. Information read by the scanner 120 is transmitted to the checkout computer 118.

In another embodiment of the present invention, the customer direct orders the products from the user interface 100. In which case, a scanner 124 and a direct-order computer 122 identify and capture, respectively, the price of the shopping basket items.

The direct-order computer 122 is any suitable personal computer, workstation, server, or other device, such as the computer system 802 of FIG. 8. The direct-order computer 122 communicates to the retailer side network 116 using any suitable protocol and may be implemented using the computer system 802 of FIG. 8, for example.

The scanner 124 may be implemented as any conventional scanning device for reading product information such as an item code (e.g., UDC, EAN, or JAN) from bar codes or other indicia on the product. Information read by the scanner 124 is transmitted to the direct-order computer 122.

The checkout computer 118 and the direct-order computer 122 contain certain contents of the control database 114 stored locally at the retail site to insure that the shopping basket items can be identified, even if network problems temporarily disable the connection with the central computer 108. Software for implementing the present invention can reside anywhere on the network, but preferably resides in the central computer 108. The control database 112 is updated from the central computer upon determination of price and availability changes. In one embodiment of the present invention, the control data base resides on a server connected via the retailer-side network 116 to the checkout computer 218 such that the checkout computer 218 looks to the server to provide an updated control database.

In another embodiment of the present invention, the control database resides on a server (not shown) connected via the retailer-side network 116 to the direct-order computer 122. Further, the server and the central computer 108 can be the same computer.

FIG. 4 is a flowchart showing a selection process of the online shopping method of the present invention. In step 400, a customer accesses the shopping menu, preferably via Internet access to the world wide web page 110 or another electronic page which advertises the shopping method of the present invention. Within the central computer 108 exists the global database 112 of retailers in which the database includes with each retailer a list of products, prices, and availability. At step 402, the central computer 108 determines a shopping district for the customer from based on customer-derived information. This determination occurs by default to previous shopping districts used by the user or by determining a shopping district from area code or zip code information about the customer. The shopping district defines an area in which the customer will travel to purchase specific items or a group of specific items.

In step 402, the customer may specify a travel distance to obtain the particular item to be purchased or the group of items to be purchased. In one embodiment, the central computer 108 selects a default shopping district based on the customer's zip code or area code, obtained at initial login, and the region in which the customer has historically shopped. In another embodiment, the central computer 108 selects a default shopping district which has been historically used by the customer. In another embodiment, the central computer 108 selects a remote shopping district where the customer may prefer to shop while away from the customer's residence or business.

In step 404, the central computer generates a present order list from the user's selection of a specific item or a group of items which are to be purchased. Alternatively, in step 406, the central computer 108 generates an order list from a menu of recurrent purchases from which the user selects. Upon selection of one of the recurrent orders, the central computer 108 displays a list of items in the selected recurrent order. The central computer 108 updates the selected recurrent order based on input from the user, thus generating a present order list.

In step 410, the central computer 108 selects those retailers from the global database which have items on the present order list. A tally of an actual price for a particular item or a group of specific items is then calculated for each retailer having the specific items within the shopping district. In step 412, the selected database is displayed (e.g. FIG. 2) to the user. The price and availability of each item on the present order list is shown. In one embodiment of the present invention, a total purchase price at each retailer is shown to the user.

In step 414, the customer selects which retailer or retailers from which to purchase all or part of the items of the present order list. Thereby, the central computer 108 forms a shopping basket (see for example the shopping basket table in FIG. 3). The shopping basket includes selected items from the present order list and prices for those items (i.e. shopping basket prices). These prices are determined by the latest price information obtained from each individual retailer. This price information is negotiated with the retailers and is implemented on a fixed schedule (i.e. on 1:00 AM of Wednesday, Nov. 1, 2000) or on a rolling time (i.e. 24 hrs. from the end of negotiations). The price information may be discounted by rebate from the online shopping service provider. With the shopping basket complete, the user confirms which items in the shopping basket items are to be purchased, and thereby confirms which retailers will be used.

In step 416, the central computer 108 forms a to-be-purchased list from the selected shopping basket items. The customer can decide to proceed directly to the selected retailers to purchase the items of the present order list. In which case, the central computer 108 directs the printer 106 to print purchase coupons with a personal identification number listing the customer, the selected retailer for each product, and the specific to-be-purchased list at that retailer. Alternatively, by customer authorization, the central computer 108 issues a direct-order to each selected retailer.

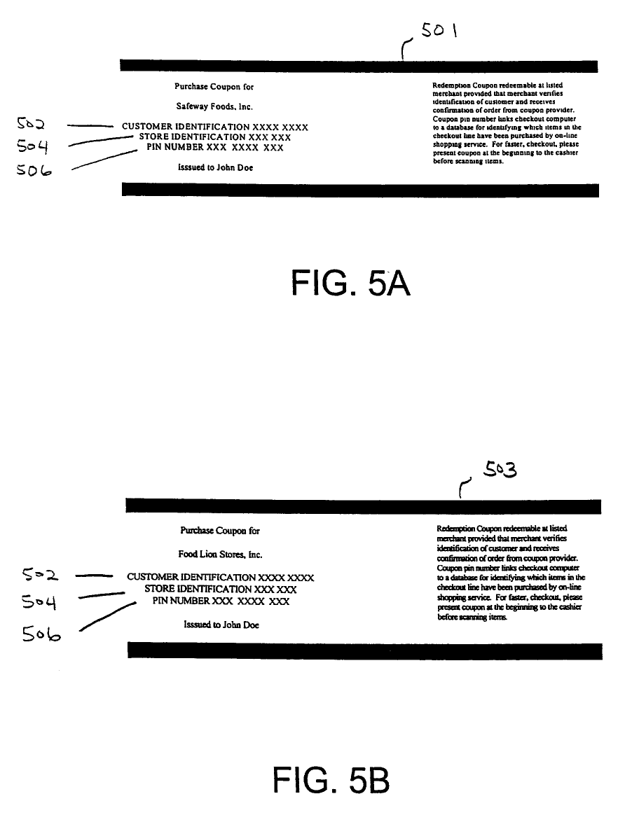

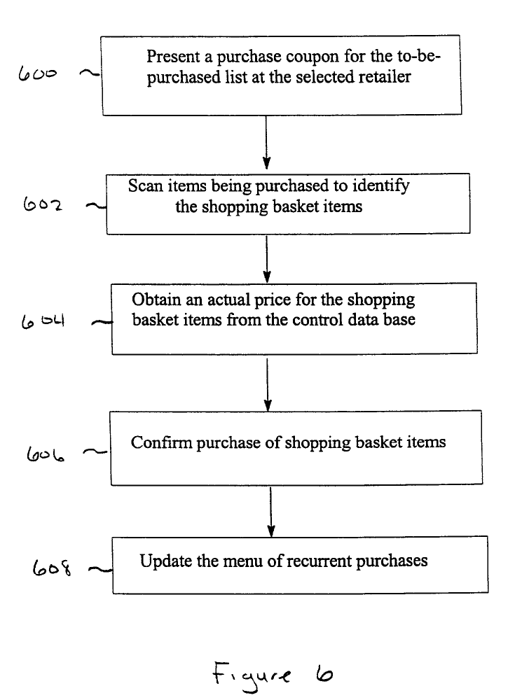

FIGS. 5A and 5B are various examples of purchase coupons that may be printed at the printer 106, for example. As shown in FIGS. 5A and 5B, each purchase coupon 501 includes customer identification information 502, store identification 504, and the personal identification number (PIN) 506 unique to the specific purchase to be made at the selected retailer. PIN technology such as described in U.S. Pat. Nos. 5,915,007 and 5,892,827, each of which is incorporated herein by reference, may be used in the present invention.

FIG. 6 is a flowchart showing a purchasing process utilizing the online shopping method of the present invention. In step 600, the user, now a customer, presents the purchase coupon to the at least one retailer. Once presented, the purchase coupon is scanned to provide the retailer with the personal identification number which links the customer to the to-be-purchased list. At step 602, the items being purchased by the customer, which may include more items than those items included by the purchase coupon, are scanned by the scanner 120 to identify the shopping basket items. The identification occurs by the checkout computer 118 which, by referencing the purchase personal identification number, obtains in step 604 an actual price contained in the control database 114. The actual price may be different than the price guaranteed on the purchase coupon. For example, a retailer wanting to provide incentives to those customers using the on-line shopping method of the present invention may instruct the local computer to further discount prices for the shopping basket items.

In step 606, the purchase of the shopping basket items at the retailer is confirmed, and in step 608, the menu of recurrent purchases made by the customer is updated to reflect the customer's latest purchase. Included in this update are the actual prices paid by the customer.

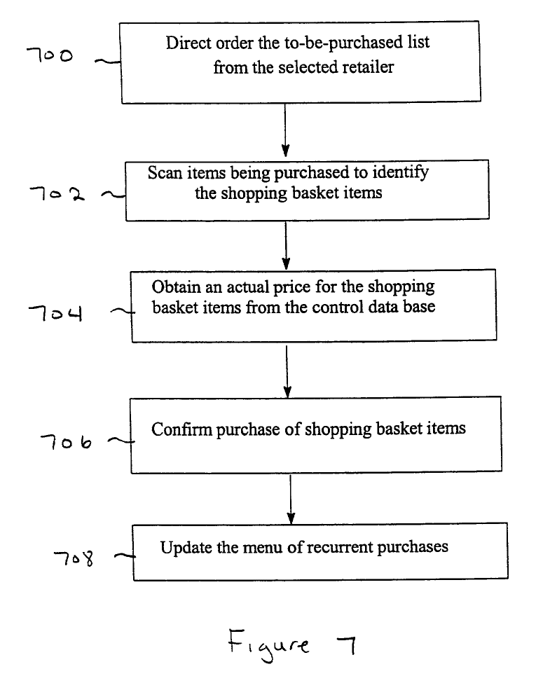

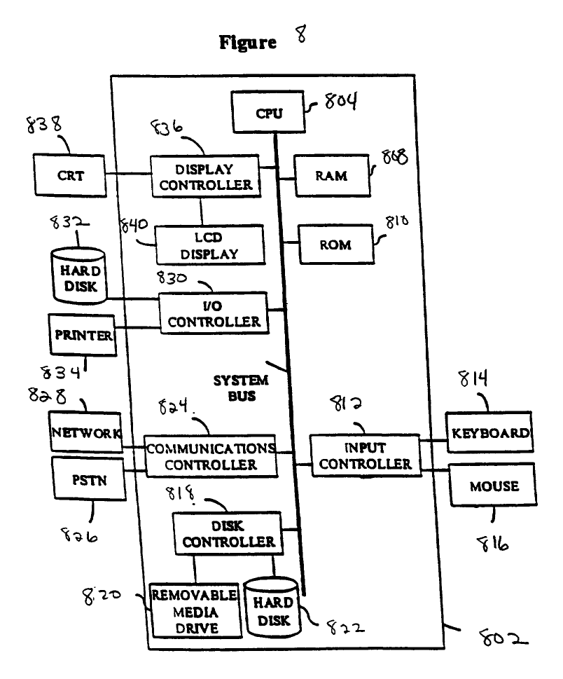

FIG. 7 is a flowchart showing another purchasing process utilizing the online shopping method of the present invention. The flowchart in FIG. 7 differs from the flowchart of FIG. 6 only in the first step, step 700. In step 700, a direct order containing a purchase invoice number is received by the direct-order computer 122 at the selected retailer. At step 702, the items being purchased by the customer are scanned by the scanner 124 to identify the shopping basket items. In step 704, the direct-order computer 122, by referencing the control database 114, obtains a price from the price data in the control database.

As previously mentioned, the price obtained may be lower than the price the customer originally confirmed. For example, a retailer wanting to provide incentives to those customers for using the shopping method of the present invention may instruct the local computer to further discount prices for the shopping basket items. In step 706, the purchase of the shopping basket items at the selected retailer is confirmed. In step 708, the menu of recurrent purchases made by the customer is updated to reflect the customer's latest purchase and the latest prices paid.

Hence according to the present invention, an online shopping system is a system including a determination device which determines a shopping district for a customer, a first generation device which generates a present order list of at least one item to price, a selection device which selects from the global database 112 of retailers those selected retailers within the shopping district selling items on the present order list, a display 104 which displays a list of the selected retailers along with a price and an availability of the items, a second generation device which generates from the list of selected retailers a shopping basket including selected items to be purchased and shopping-basket prices for the selected items, and a forming device which forms the to-be-purchased list from the shopping basket list. The central computer 108 functions as the determining device. The customer interface 100, the central computer 108, and the display 104 all function together as the first and second generation devices and the forming device.

The system further includes an identification device which identifies the purchase coupon at the retail store, a scanning device 120 or 124 which scans the purchase coupon to identify which checkout items were selected by the customer to be in the shopping basket, and a pricing device which prices the identified checkout items with an actual price no greater than a shopping basket price found in the control database 114. The checkout computer 118 and the direct-order computer 122 along with the scanners 120, 124 respectively serve as the identification device.

The aforesaid methods and devices for the online shopping method are contained according to this invention on a computer program product. The computer program product is a storage medium including instructions which can be used to program a computer or a formality of networked computers to perform a process of the invention. The storage medium include, but is not limited to, any type of disc including floppy disk, optical disk, CD-ROMs, a magneto-optical disc, ROMs, RAMs, EPROMs, EEPROMs, magnetic or optical cards, or any type of medium suitable for storing electronic instructions.

The invention may be conveniently implemented using a general purpose digital computer or a network of general purpose digital computers and/or microprocessors programmed according to the teachings of the present specification, as will be apparent to those skilled in the computer art from reading the above description regarding the figures. Appropriate software coding can readily prepared by skilled programmers based on the teachings of the present disclosure, as will be apparent to those skilled in the software art. This invention may also be implemented by the preparation of applications specific integrated circuits or by interconnecting an appropriate network or conventional component circuits, as will be readily apparent to those skilled in the art.

It is to be understood that the system in FIG. 1 is for exemplary purposes only, as many variations of the specific hardware and software used to implement the present invention will be readily apparent to one having ordinary skill in the art. For example, the functionality of the checkout computer 118 and the scanner 120 may be combined in a single device. These implementations and other implementations of computer systems are described in greater detail in one or more of U.S. Pat. Nos. 4,723,212; 4,910,672; 5,173,851; 5,612,868; and 6,026,370, each of which is incorporated herein by reference. To implement these variations as well as other variations, a single computer (e.g., the central computer 108 of FIG. 1) may be programmed to perform the special purpose functions of two or more of any of the devices shown in FIG. 1. On the other hand, two or more programmed computers may be substituted for any one of the devices shown in FIG. 1. Principles and advantages of distributed processing, such as redundancy and replication, may also be implemented as desired to increase the robustness and performance of the system, for example.

FIG. 8 is a block diagram of an exemplary computer 802 that may be used to implement the present invention. The computer 802 can be a personal computer, a portable computer, a computer workstation with sufficient memory and processing capability, or any device configured to work like a computer. In this embodiment, the computer 802 includes a central processing unit 804 (CPU) that communicates with a number of other devices by way of a system bus 806. The computer 802 includes a random access memory (RAM) 808 that stores temporary values used in implementing the print job.

The central processing unit 804 is configured for high volume data transmission and for performing a significant number of mathematical calculations in processing the print jobs. A Pentium III microprocessor such as the 1 GHz Pentium III manufactured by Intel Inc. may be used for CPU 804. The processor employs a 32-bit architecture. Other suitable processors include the Motorola 500 MHZ power PC G4 processor and the Advanced Micro Devices 1 GHz AMD Athlon processor. Multiple processors and workstations may be used as well.

The ROM 810 is preferably included in a semiconductor form although other read only memory forms including optical medium may be used to host application software and temporary results. The ROM 810 connects to the system bus 806 for use by the CPU 804. The ROM 810 includes computer readable instructions that, when executed by the CPU 804, perform different functions associated with printing and managing print jobs. An input control 812 connects to the system bus 806 and provides an interface with various peripheral equipment including a keyboard 814 and a pointing device such as a mouse 816 settles to remit user interaction with graphical user interfaces. The input controller 812 may include different ports such as a mouse port in the form of a PS2 port or, for example, a universal serial bus (USB) port. The keyboard port for the input controller 812 is in the form of a mini-DIN port although other connectors may be used as well. The input controller 812 also may include serial ports or parallel ports as well.

A disc controller 818 is in the form of an IDE controller and connects via driving cables to a removal media drive 820 which may be implemented as a floppy disc drive, as well as a hard disc drive 822 and a CD-ROM drive (not shown). In addition, a PCI expansion slide is provided on a disc controller 818 or a motherboard that hosts the CPU 804. An enhanced graphic port expansion slot is provided and provides 3-D graphics with fast access to the main memory. The hard disc 822 may also include a CD drive that may be readable as well as writable. A communication controller 824 provides a connection to a network L1. The network L1 may be a connection to the public switched telephone network (PSTN) 826 for providing Internet access, or to a network 828 such as a local area network, wide area network, a virtual private network (VPN), or an extranet. In one embodiment, the network L1 and the connection to the communication controller 824 are made by way of a plurality of connections including a cable-modem connection, digital subscriber line (DSL) connection, fiber optic connection, dial-up modem connection, and the like that connects to the communication controller 824.

An input/output controller 830 also provides connections to the external components such as an external hard disc drive 832, a printer 834, for example, by way of an RS 232 port and a SCSI bus.

A display controller 836 interconnects the system bus 806 to a display device, such as a cathode ray tube (CRT) 838. While a CRT is shown, a variety of display devices may be used such as an LCD (liquid crystal display) 840, or plasma display device. The display device permits displaying of graphical user interfaces.

The computer devices of the present invention may be any interpreted or executable code mechanism, including but not limited to scripts, interpreters, dynamic link libraries, Java classes, and complete executable programs. Moreover, parts of the processing of the present invention may be distributed for better performance, reliability, and/or cost.

The term “computer readable medium” as used herein refers to any medium that participates in providing instructions to CPU 804 for execution. A computer readable medium may take many forms, including but not limited to, non-volatile media, volatile media, and transmission media. Non-volatile media includes, for example, optical, magnetic disks, and magneto-optical disks. Volatile media includes dynamic memory, such as RAM 808. Transmission media includes coaxial cables, copper wire and fiber optics, including the wires that comprise bus 806. Transmission media also may also take the form of acoustic or light waves, such as those generated during radio wave and infrared data communications.

Common forms of computer readable media include, for example, hard disks, floppy disks, tape, magneto-optical disks, PROMs (EPROM, EEPROM, Flash EPROM), DRAM, SRAM, SDRAM, or any other magnetic medium, compact disks (e.g., CD-ROM), or any other optical medium, punch cards, paper tape, or other physical medium with patterns of holes, a carrier wave (described below), or any other medium from which a computer can read.

Various forms of computer readable media may be involved in carrying out one or more sequences of one or more instructions to CPU 804 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 802 may receive the data on the telephone line and use an infrared transmitter to convert the data to an infrared signal. The instructions received by the CPU 804 may optionally be stored on storage devices either before or after execution.

Numerous modifications and variations of the present invention are possible in light of the above teachings. It is therefore to be understood that within the scope of the appended claims, the invention may be practiced otherwise than as specifically described herein.

1. A computer-implemented method comprising:
determining a shopping district for a customer based on customer-derived information;
generating a present order list of at least one item to price;
selecting from a global database of retailers selected retailers within the shopping district selling the at least one item;
forming a selection list of the selected retailers to be displayed to the customer, said list including,
a price of the at least one item, and
an availability of the at least one item;
generating from the selection list a shopping basket including selected items and shopping basket prices of the selected items to be purchased; and
forming a to-be-purchased list for at least a part of the shopping basket list.

2. The method of claim 1, wherein the step of determining a shopping district comprises:
determining a zip code of the customer; and
restricting the shopping district to an area within the zip code.

3. The method of claim 1, wherein the step of determining a shopping district comprises:
determining a residence of the customer; and
restricting the shopping district to an area within a predetermined distance of the customer residence.

4. The method of claim 1, wherein the step of determining a shopping district comprises:
determining a remote shopping district for the customer in which the customer purchases items.

5. The method of claim 1, wherein the step of generating a present order list comprises:
entering the at least one item into the present order list.

6. The method of claim 1, wherein the step of generating a present order list comprises:
selecting a pre-existing order list; and
updating the pre-existing order list to generate the present order list.

7. The method of claim 1, wherein the step of selecting comprises:
confirming at each selected retailer an actual price from the global database for each available item in the present order list.

8. The method of claim 7, wherein the step of forming a selection list comprises:
displaying the actual price at each selected retailer for each item of the shopping basket list.

9. The method of claim 8, wherein the step of displaying an actual price comprises:
displaying at least one of an actual price history and an availability history at each selected retailer for each item of the shopping basket list.

10. The method of claim 8, wherein the step of displaying comprises:
displaying at least one of an inventory list and shopping hours at each selected retailer for each item of the shopping basket list.

11. The method of claim 1, wherein the step of displaying comprises:
displaying a total price at each selected retailer for available items in the shopping basket at said each retailer.

12. The method of claim 11, wherein the step of forming a to-be-purchased list comprises:
selecting which items in the shopping basket are to be purchased;
confirming that the selected items are to be purchased; and
forming said to-be-purchased list with the confirmed items.

13. The method of claim 12, further comprising the step of:
providing a purchase coupon for redemption at the confirmed retailer.

14. The method of claim 13, further comprising:
identifying the purchase coupon at the confirmed retailer;
scanning checkout items at the confirmed retailer;
identifying which checkout items are in the to-be-purchased list; and
pricing the identified checkout items with an actual price no greater than the shopping basket price.

15. The method of claim 14, wherein the step of pricing comprises:
referencing the shopping basket price from a control database having confirmed prices for the selected retailer.

16. The method of claim 14, further comprising:
transmitting a list of the checkout items and actual prices at the confirmed retailer to the global database, said transmitted list comprising a pre-existing order.

17. The method of claim 12, further comprising the step of:
direct-ordering from each confirmed retailer the selected items in the to-be-purchased list.

18. The method of claim 17, further comprising:
pricing the selected items with actual prices no greater than the shopping basket prices.

19. The method of claim 18, wherein the step of pricing comprises:
referencing the shopping basket prices from the global database.

20. The method of claim 18, further comprising:
transmitting a list of the selected items and the actual prices into the global database at the confirmed retailer, said transmitted list comprising a pre-existing order.

21. An online shopping system comprising:
a determination device configured to determine a shopping district for a customer;
a first generation device configured to generate a present order list of at least one item to price;
a selection device configured to select from a global database of retailers those selected retailers within the shopping district selling the at least one item;
a display configured to display to the customer a list of the selected retailers, said list including,
a price of the at least one item, and
an availability of the at least one item;
a second generation device configured to generate from the list of selected retailers a shopping basket including selected items and shopping basket prices of the selected items to be purchased; and
a forming device configured to form a to-be-purchased list for at least a part of the shopping basket list.

22. The system of claim 21, wherein the determination device is configured to determine a zip code of the customer and restrict the shopping district to an area within the zip code.

23. The system of claim 21, wherein the determination device is configured to determine a residence of the customer and restrict the shopping district to an area within a predetermined distance of the customer residence.

24. The system of claim 21, wherein the determination device is configured to determine a remote shopping district for the customer in which the customer purchases items.

25. The system of claim 21, wherein the first generation device is configured to enter the at least one item into the present order list.

26. The system of claim 21, wherein the first generation device is configured to select a pre-existing order list and update the pre-existing order list to generate the present order list.

27. The system of claim 21, wherein the selection device is configured to confirm at each selected retailer an actual price for each available item in the present order list.

28. The system of claim 27, wherein the display is configured to display the actual price at each selected retailer for each item of the shopping basket list.

29. The system of claim 28, wherein the display is configured to display at least one of an actual price history and an availability history at each selected retailer for each item of the shopping basket list.

30. The system of claim 28, wherein the display is configured to display at least one of an inventory list and shopping hours at each selected retailer for each item of the shopping basket list.

31. The system of claim 21, wherein the display is configured to display a total price at each selected retailer for available items in the shopping basket at said each retailer.

32. The system of claim 31, wherein the forming device is configured to select which items in the shopping basket are to be purchased, confirm that the selected items are to be purchased, and form said to-be-purchased list with the confirmed items.

33. The system of claim 32, further comprising:
an issue device configured to provide a purchase coupon for redemption at the confirmed retailer.

34. The system of claim 33, further comprising:
an identification device configured to identify the purchase coupon at the confirmed retailer;
a scanning device configured to scan checkout items at the confirmed retailer; and
a checkout computer configured to identify which of the scanned items are the selected items and to price the identified checkout items with actual prices no greater than the shopping basket prices.

35. The system of claim 34, wherein the checkout computer is configured to reference the actual prices from a control database having confirmed prices for the selected retailer.

36. The system of claim 34, wherein the checkout computer is configured to transmit a list of the checkout items at the confirmed retailer to the global database, the transmitted list comprising a pre-existing order.

37. The system of claim 32, further comprising:
a direct-order device configured to direct-order from each confirmed retailer the selected items in the shopping basket.

38. The system of claim 37, further comprising:
a checkout computer configured to price the confirmed items with actual prices no greater than the shopping basket prices.

39. The system of claim 38, wherein the checkout computer is configured to reference the shopping basket prices from the global database.

40. The system of claim 38, wherein the checkout computer is configured to transmit a list of the selected items and the actual prices at the confirmed retailer into the global database, said transmitted list comprising a pre-existing order.

41. A computer readable medium containing program instructions for execution on a computer system, which when executed by the computer system, cause the computer system to perform the method recited in any one of claims 1-20.
